(19) United States
(12) Patent Application Publication
(10) Pub. No.: US 2009/0280278 A1
(43) Pub. Date: Nov. 12, 2009

(54) MULTILAYER FILM

(75) Inventors: Rainer Brandt, Walsrode (DE); Gregor Kaschel, Bomlitz (DE); Esko Saaristo, Nastola (FI); Timo Toivola, Lahti (FI)

Correspondence Address: NORRIS, MCLAUGHLIN & MARCUS, P.A., 875 THIRD AVE, 18TH FLOOR, NEW YORK, NY, 10022, US

(73) Assignee: WIPAK WALSRODE GMBH & CO. KG, Walsrode (DE)

(21) Appl. No.: 12/307,429

(22) PCT Filed: Jul. 4, 2007
(86) PCT No.: PCT/EP2007/005896

§ 371 Date: Mar. 18, 2009

(30) Foreign Application Priority Data
Jul. 7, 2006 (DE) 10 2006 031 841.2

(51) Int. Cl. B32B 27/08; B29C 65/02; B32B 1/08; B32B 7/02

(52) U.S. Cl. 428/35.2; 156/308.2; 428/335; 428/220; 428/213

(57) ABSTRACT

Multilayer film with a layer A, based on a thermoplastic polymer or on a mixture of a plurality of thermoplastic polymers with melting point Tₘ^{A} and a VICAT softening point Tᵥ^{A}, and which has a thickness of at most 40 μm; and a layer B, which is immediately adjacent to layer A, and is based on a thermoplastic polymer or on a mixture of a plurality of thermoplastic polymers with melting point Tₘ^{B}, a VICAT softening point Tᵥ^{B}, and a thickness of at most 50 μm;

where
Tᵥ^{B}<Tᵥ^{A} and Tₘ^{B}<Tₘ^{A};
Tᵥ^{B}≦115° C.;
having at least one at least monoaxially oriented layer and an external sealable layer; and a region D between layer A and layer B that has been printed and/or metallized and/or coated with a semi-metal oxide; the adhesion between layer A and layer B being at least 1.0 N/15 mm.

The invention relates to a multilayer film which is suitable in particular for producing food packaging. The invention further relates to a process for the production of this multilayer film.

Multilayer composites composed of oriented films have good suitability for use as packaging materials for sensitive contents. For various reasons, it is desirable the composites have been printed or have been metallized and/or have been coated with a (semi)metal oxide. By way of example, printed images can be used to provide information, and regions that have been metallized and/or that have been coated with (semi)metal oxides contribute to barrier action with respect to moisture, gases, and aromas, and can also have attendant esthetic advantages.

The region that has been printed or has been metallized and/or that has been coated with a (semi)metal oxide should as far as possible have been arranged internally, i.e. between at least two layers of the composite, in order that it has protection from exterior mechanical effects.

However, multilayer films with an internal region that has been printed and/or that has been metallized and/or that has been coated with a (semi)metal oxide cannot be produced in a single step when conventional processes are used. These composites are usually produced via a multistage process where two films are first produced independently of one another, and the external surface of at least one these films is printed or metallized, or coated with a (semi)metal oxide. The two films are then bonded with the aid of suitable lamination adhesives to give a multilayer film in such a way that the region that has been printed and/or that has been metallized and/or that has been coated with a (semi)metal oxide has been arranged between two films. If at least one of the two films is transparent, the region that has been printed and/or that has been metallized and/or that has been coated with a (semi)metal oxide is visible from the outside.

The lamination adhesives provide satisfactory adhesion between the films. At the time of application they permit wetting of the surface of the films, and also in particular of the region that has been printed and/or that has been metallized and/or that has been coated with a (semi)metal oxide, and they cure in the adhesive-bonded joint.

However, one of the disadvantages of lamination adhesives is that they have to harden, and this usually requires a number of days, and sometimes up to two weeks, and the composite cannot therefore be further processed immediately as a packaging material. Composite films which comprise hardened lamination adhesives moreover have severely restricted recyclability.

A possible disadvantage of lamination adhesives, as a function of the packaged product, is that they absorb color pigments. It is known in particular in the packaging of spices, for example of curry, that the pigments present in the spice can diffuse over time through the individual layers of the packaging and finally reach the lamination adhesive, where they are absorbed. This leads inter alia to a mottled outward appearance of the packaging.

Multilayer films which comprise lamination adhesives moreover have a very restricted suitability for the packaging of perishable foods. By way of example, hardened lamination adhesive usually comprise residues of substances that can migrate and which are hazardous to health or indeed toxic, and can diffuse from the packaging into the food. Examples of these substances that can migrate are certain isocyanates and certain primary amines, these being typical constituents of lamination adhesives. In this connection, reference can also be made to B. D. Page et al., Food Addit Contam. 1992, 9(3), 197-212; T. P. McNeal et al., J AOAC Int. 1993, 76(6), 1268-75; M. Sharman et al., Food Addit Contam. 1995, 12(6), 779-87; G. Lawson et al., Anal Bioanal Chem. 1996, 354(4), 483-9; G. Lawson et al., Analyst. 2000, 125(1), 115-8; and A. P. Leber, Chem Biol Interact. 2001,135-136, 215-20. If adhesives harden correctly, the requirements of food legislation are met. However, the hardening process is very long and requires monitoring, requiring a considerable amount of money and time.

About 40% of the isocyanate-containing lamination adhesives used currently moreover comprise organic solvents, which are emitted during the production of composite films. Elimination of said emissions forms part of an integrated approach to protection of the environment.

The prior art discloses various approaches to avoidance of the disadvantages of conventional lamination adhesives.

By way of example, lamination adhesives have been developed where the proportion of substances which can migrate and are hazardous to health is lower, after hardening, than in conventional lamination adhesives. However, said lamination adhesives are not satisfactory in every respect. By way of example, they are firstly comparatively expensive, and secondly—as a function of the nature of the material in the films to be bonded—the adhesion is not always adequate to meet the requirements placed upon the packaging material, and they mostly have prolonged hardening times.

Multilayer films have also been developed which have a barrier layer, so that the constituents that can migrate are prevented from reaching the packaged product. However, specific materials have to be used to produce these barrier layers, and this makes the production of the multilayer films comparatively complicated and expensive.

The prior art also discloses a variety of approaches for bonding two prefabricated films to one another without the use of lamination adhesives.

Am example is EP-A 1 167 017, which discloses a process in which polyethylene (PE) is melted in an extruder and is applied between two BOPP films (extrusion lamination), where one of the BOPP films has been printed, and the other has been metallized. The BOPP films are bonded to one another via hardening of the polyethylene, in such a way that the metallized side and the printing ink are inside.

Although extrusion lamination can eliminate lamination adhesives, it has the disadvantage that the polymer has to be heated to a comparatively high temperature during the extrusion process, thus usually increasing the requirements that have to be placed upon the thermal stability of the printing inks and metallized films, and requiring particular measures to prevent curl of the resultant composite. Another requirement, because of the high temperature of the extruded polymer melt, is that the film to be coated has adequate thermal stability. By way of example, the polymer melt, whose temperature, as a function of polymer, is in the region of 300° C., cannot be permitted to damage the film to be coated. BOPP is at particular risk here, since its melting point is comparatively low: about 164° C. Films which have been printed and/or which have been coated using vacuum technology are also at risk, since application of the hot melt takes place with direct contact. The results are cracks in the layer applied using vacuum technology, alterations in the printed image, etc. The extruded layer moreover has a certain minimum thickness, for reasons of production technology, and this is attended by increased use of material. However, a particular disadvantage of extrusion lamination is that the adhesion between the extruded layer and the two layers bonded thereby is relatively low, mostly below 1.0 N/15 mm.

U.S. Pat. No. 6,368,722 discloses laminated multilayer films produced by dissolving a heat-resistant polymer in a dipolar aprotic solvent, e.g. N-methyl-2-pyrrolidone. The solution is then applied to an oriented film and dried at an elevated temperature.

Although said process requires no lamination adhesives, the composites nevertheless usually comprise considerable residual amounts of solvents which are hazardous to health. Said process cannot moreover join surface-printed films, since the printing ink would be attacked by the solvent.

The prior art also discloses production of composites via heat-lamination. This process usually takes a film which has a heat-laminatable layer on one of its surfaces, and joins it to a substrate by using heat and pressure. Although heat-lamination can likewise operate without use of lamination adhesives, the processes known hitherto are usually used (cf. e.g. EP-A 263 882) for the production of composites composed of a plastics film and of a printed or unprinted porous substrate composed of card, paperboard, or paper.

There is a need for multilayer films with an internal region that has been printed and/or has been metallized and/or that has been coated with a (semi)metal oxide, where the films use absolutely no lamination adhesives and nevertheless have excellent adhesion between the layers joined. There is moreover a requirement for multilayer films with an internal printed region, where these can be produced by processes which require only a short time.

The invention is based on the object of providing multilayer films with an internal region that has been printed and/or that has been metallized and/or that has been coated with a (semi)metal oxide, where the films have advantages over the multilayer films of the prior art. The multilayer films should be suitable as packaging materials for perishable foods, and be capable of low-cost production, and have good adhesion between the layers in the region that has been printed and/that has been metallized and/or that has been coated with a (semi)metal oxide. The multilayer films should require no substances that can migrate and are attended by health risks, and should comply with technical requirements, in particular a high level of barrier properties with respect to water vapor and oxygen, and their production costs should be capable of competing with those of conventional multilayer films. The films should moreover be capable of use as packaging materials very shortly after their production, i.e. it should be possible to operate without prolonged periods for cooling and/or for hardening. In the most advantageous case, the periods between the production of the multilayer film and its suitability for use on a packaging machine should be less than one hour, preferably less than 10 minutes.

The subject matter of the claims achieves said object.

Surprisingly, it has been found that multilayer films can be produced from two films produced independently of one another, where one of the external surfaces of at least one of these films has a region D that has been printed and/or that has been metallized and/or that has been coated with a (semi)metal oxide, where excellent adhesion values are achieved, without any need to use lamination adhesives for this purpose.

This is particularly surprising because it had been assumed that the usual result of a region that has been printed and/or that has been metallized and/or that has been coated with a (semi)metal oxide is significant impairment of adhesion.

The multilayer films of the invention moreover have excellent sensory properties, i.e. are superior to many conventional multilayer films for example with regard to retention of the odor and taste of the packaged product.

The invention provides a multilayer film encompassing
layer A, which is based on a thermoplastic polymer or on a mixture of a plurality of thermoplastic polymers with melting point Tₘ^{A} and with VICAT softening point Tᵥ^{A}, and which has a thickness of at most 40 μm, preferably at most 35 μm, more preferably at most 30 μm, still more preferably at most 25 μm, most preferably at most 20 μm, and in particular at most 15 μm; and
layer B, which is immediately adjacent to layer A, and which is based on a thermoplastic polymer or on a mixture of a plurality of thermoplastic polymers with melting point Tₘ^{B} and with VICAT softening point Tᵥ^{B}, and which has a thickness of at most 50 μm, preferably at most 40 μm, more preferably at most 30 μm, still more preferably at most 20 μm, most preferably at most 15 μm, and in particular at most 10 μm;
   where
Tᵥ^{B}<Tᵥ^{A} and Tₘ^{B}<Tₘ^{A}, preferably Tᵥ^{B}≦Tᵥ^{A}≦Tₘ^{B}≦Tₘ^{A} or Tᵥ^{B}≦Tₘ^{B}<Tᵥ^{A}≦TₘA; Tᵥ^{B}≦115° C.; preferably Tᵥ^{B}=80±35° C.; more preferably Tᵥ^{B}=70±25° C., 80±25° C., or 90±25° C.; still more preferably Tᵥ^{B}=65±20° C., 75±20° C., 85±20° C., or 95±20° C.; most preferably Tᵥ^{B}=60±15° C., 70±15° C., 80±15° C., 90±15° C., or 100±15° C.; and in particular Tᵥ^{B}=55±10° C., 60±10° C., 65±10° C., 70±10° C., 75±10° C., 80±10° C., 85±10° C., 90±10° C., 95±10° C., 100±10° C., or 105±10° C.;
preferably Tₘ^{B}=110±35° C.; more preferably Tₘ^{B}=100±25° C., 110±25, or 120±25° C.; still more preferably Tₘ^{B}=95±20° C., 105±20° C., 115±20° C., or 125±20° C.; most preferably Tₘ^{B}=80±15° C., 90±15° C., 100±15° C., 110±15° C., 120±15° C., or 130±15° C.; and in particular Tₘ^{B}=85±10° C., 90±10° C., 95±10° C., 100±10° C., 105±10° C., 110±10° C., 115±10° C., 120±10° C., 125±10° C., 130±10° C., or 135±10° C.;
and the multilayer film encompasses at least one, preferably at least two, more preferably at least three, at least monoaxially, preferably biaxially oriented layer(s);
and the multilayer film encompasses an external sealable layer;
and between layer A and layer B the arrangement has a region D that has been printed and/or that has been metallized and/or that has been coated with a (semi)-metal oxide; and
the adhesion between layer A and layer B is at least 1.0 N/15 mm, preferably at least 1.5 N/15 mm, at least 2.0 N/15 mm, or at least 2.5 N/15 mm, more preferably at least 3.0 N/15 mm, at least 3.5 N/15 mm, or at least 4.0 N/15 mm, still more preferably at least 4.5 N/15 mm, at least 5.0 N/15 mm, or at least 5.5 N/15 mm, most preferably at least 6.0 N/15 mm, at least 6.5 N/15 mm, or at least 7.0 N/15 mm, and in particular at least 7.5 N/15 mm, at least 8.0 N/15 mm, or at least 8.5 N/15 mm, preferably determined to DIN 53 357, method B.

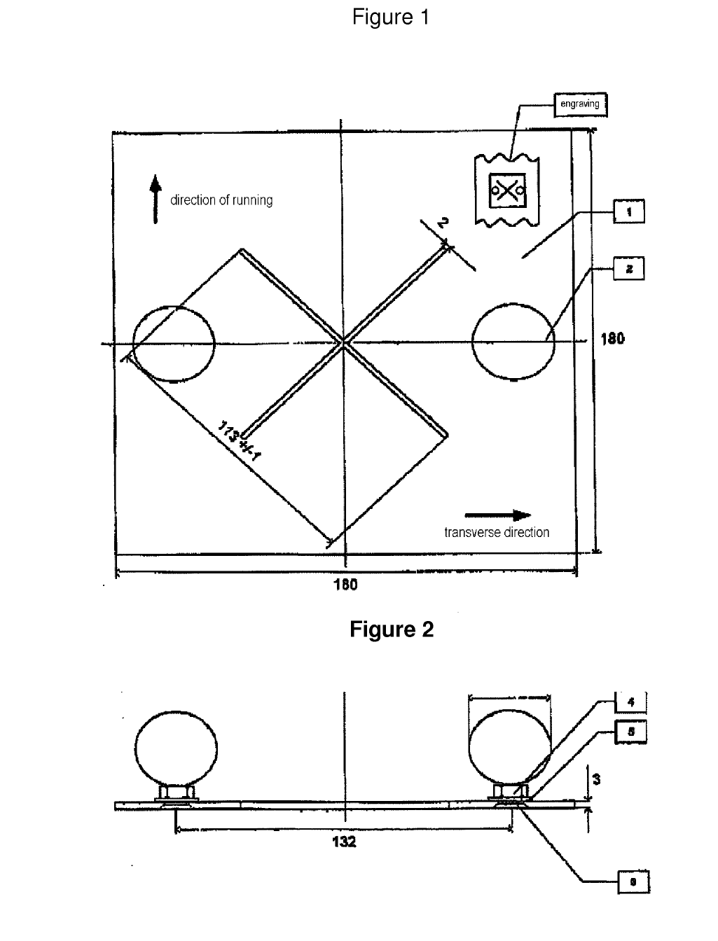

FIGS. 1 and 2 show a template which is preferably used for determination of the curl of the multilayer film of the invention.

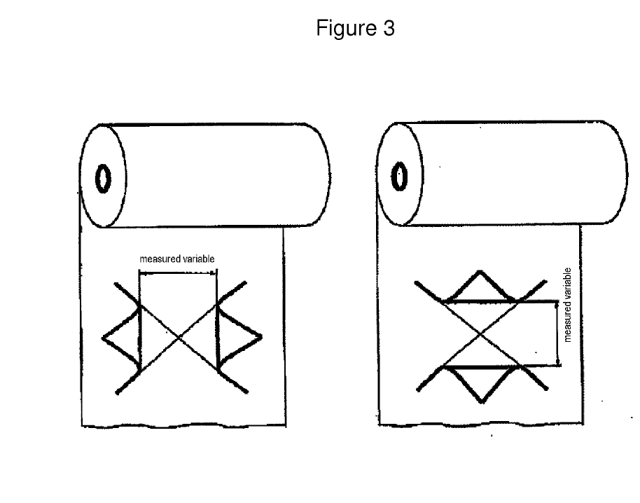

FIG. 3 is a diagram of the curl of multilayer film, transversely (left-hand side) and longitudinally (right-hand side) with respect to the film web.

The multilayer films of the invention are particularly suitable for the packaging of perishable foods, since it is possible to exclude very substantially any contamination of the packaged product by substances that can migrate.

The multilayer film of the invention has, between layer A and layer B, a region D that has been printed and/or that has been metallized and/or that has been coated with a (semi)metal oxide. The term “A-D-B” is used below to express this. Since the region D is not an independent layer of the multilayer film, layer A is immediately adjacent to layer B, i.e. there is no other layer between layer A and layer B.

The region D can cover the entire main plane (area) of the multilayer film, or only a portion thereof.

In one preferred embodiment, the region D covers the entire main plane of the multilayer film. This embodiment is preferred particularly when the region D is a region that has been metallized and/or that has been coated with a (semi)metal oxide.

In another preferred embodiment, the region D covers less than the entire main surface of the multilayer film, preferably less than 95%, more preferably less than 90%, still more preferably less than 85%, most preferably less than 80%, and in particular less than 50%. In this case, region D can be a coherent region or a region subdivided into a plurality of subregions. This embodiment is preferred particularly when the region D is a region that has been printed and/or that has been metallized. If the region D is a region that has been metallized and which covers less than the entire main surface of the multilayer film, it is preferable that this involves a demetallized region, i.e. that during production the metallized region initially covered the entire main surface of the multilayer film, but partial ablation of the metal film (demetallization) then created regions which do not have (no longer have) metallization. The person skilled in the art is aware of suitable demetallization processes. By way of example, demetallization can be realized with the aid of etching techniques.

If the region D is a region that has been printed, it can encompass symbols or letters of the alphabet.

In one preferred embodiment, the measure used for the curl of the multilayer film of the invention comprises the distance between the curled extremities of a crosscut. It is preferable that the longitudinal and/or transverse curl of the multilayer film of the invention is at most 50 mm, more preferably at most 40 mm, still more preferably at most 30 mm, most preferably at most 20 mm, and in particular at most 10 mm. The person skilled in the art is aware of suitable methods for the determination of the curl of multilayer films. In the invention, the curl is preferably determined by what is known as the crosscut method. This is described in more detail in the experimental section.

As an alternative, the curl can also by way of example be determined by what is known as the Ronden method. If the radius of curvature is used as a measure of the curl, it is preferably determined in accordance with U.S. Pat. No. 4,565,738. The curl here is preferably at most 60°, more preferably at most 50°, still more preferably at most 40°, most preferably at most 30°, and in particular at most 20°.

Each of layer A and layer B of the multilayer film of the invention is based, independently of the other layer, on a thermoplastic polymer or on a mixture of plurality of thermoplastic polymers with melting point Tₘ^{A} and, respectively, Tₘ^{B}, and with VICAT softening point Tᵥ^{A} and, respectively, Tᵥ^{B}.

The melting point of the polymer is preferably determined by DSC to DIN ISO 11357 or ISO 3146/ASTM D3418.

If a polymer mixture is involved, the mixture is preferably tested to DIN ISO 11357 or ISO 3146/ASTM D3418, and the temperature of the main DSC peak is regarded for the purposes of the invention as melting point of the polymer mixture.

The VICAT softening point (VST A/120) of the polymer or of the polymer mixture is preferably determined to DIN EN ISO 306/ASTM D1525.

If the thermoplastic polymer has only a VICAT softening point but no melting point, for example because it involves a completely amorphous polymer, for the purposes of the invention the melting point is the same as the VICAT softening point measured (Tₘ=Tᵥ).

In one preferred embodiment of the multilayer film of the invention, neither layer A nor layer B is based on a lamination adhesive or on a lacquer. It is particularly preferable that the multilayer film of the invention encompasses no lamination adhesive and/or lacquer at all.

Lamination adhesives are known to a person skilled in the art. For the purposes of the description, a “lamination adhesive” is preferably defined as a product which, by virtue of its chemical constitution and of its physical state at the juncture of application between two layers to be bonded, permits wetting of the surface thereof and hardens in the adhesive-bonded joint by virtue of physical processes (e.g. evaporation of volatile solvents) and/or chemical reactions (e.g. formation of covalent bonds). In the dried or hardened state, a lamination adhesive preferably involves a thermoset.

It is preferable that for the purposes of the description a “lamination adhesive” involves a chemically reacting adhesive, which can cure at low or high temperature, and where the term includes polymerization adhesives, polyaddition adhesives, and polycondensation adhesives. Examples of single-component polymerization adhesives are cyanoacrylate adhesives (cyanoacrylates), and diacrylic esters. An example that may be mentioned of a two-component polymerization adhesive is a methacrylate adhesive. Example of polyaddition adhesives are epoxy resin adhesives and polyurethane adhesives. Examples that may be mentioned of polycondensation adhesives are formaldehyde condensates, certain polyamides, certain polyesters, silicones, polyimides, polybenzimidazoles, and polysulfones, but the use of these as lamination adhesives is not usual or occurs only in exceptional cases.

A widely used group of lamination adhesives is provided by the abovementioned polyurethane adhesives, i.e. products which contain isocyanates (—NCO) as free functional groups. Their adhesive action is based inter alia on the chemical reaction of the isocyanates with hydroxy groups or with other suitable functional groups, these being available on the surface of the layer to be adhesive-bonded. The result is therefore covalent linkage between the lamination adhesive and the layers, for example by way of urethane groups (—O—CO—NH—). Lamination adhesives based on (meth)acrylate are also widely used. Other functional groups which can participate in the hardening of lamination adhesives are: —NH₂, —CO₂H, —CHO, —CN, —SH, —Cl, —CH═CH₂, —CH₂CH═CH₂ and epoxy.

A distinction is made firstly between single- and multicomponent systems and secondly between lamination adhesives based on aliphatic and/or aromatic units. A further distinction is made between solvent-containing and solvent-free lamination adhesives. For further details, reference may be made by way of example to the entire contents of G. Habenicht, Kleben: Grundlagen, Technologie, Anwendungen [Adhesion: principles, technology and uses], Springer Verlag, 1986. For practical reasons, the application thickness of lamination adhesives is usually more than 0.5 μm.

A person skilled in the art is aware of lacquers. For the purposes of the description, a “lacquer” is preferably defined as a liquid which after drying forms a solid, stable, mostly glossy layer, and thus protects and, if appropriate, decorates the area on which it is provided. This preferably involves a product which by virtue of its chemical constitution and its physical state at the juncture of application to a layer permits wetting of the surface thereof, and hardens by virtue of physical processes (e.g. evaporation of volatile solvents) and/or of chemical reactions (e.g. formation of covalent bonds).

It is preferable that the multilayer film of the invention does not comprise any lacquer—besides any printing inks present in the region D that has been printed. It is particularly preferable that—besides the printing inks—the multilayer film of the invention does not comprise any further substance or composition which during the production of the multilayer film has been hardened as a consequence of chemical processes and/or through evaporation of a solvent. One of the advantages of this is that the multilayer film of the invention is more capable of recycling and suitable for the packaging of foods.

In one preferred embodiment, the multilayer film of the invention encompasses eight, seven, six, five, four, three, or only two layers. In the latter case, the multilayer film is composed of layer A and layer B, in such a way that at least layer A or layer B has been at least monoaxially stretched, and at least layer A or layer B forms an external sealable layer of the multilayer film.

In one preferred embodiment, the total thickness of the multilayer film of the invention is at most 200 μm, at most 190 μm, or at most 180 μm; more preferably at most 170 μm, at most 160 μm, or at most 150 μm; still more preferably at most 140 μm, at most 130 μm, or at most 120 μm; most preferably at most 110 μm, at most 100 μm, or at most 90 μm; and in particular at most 80 μm, at most 70 μm, or at most 60 μm.

The multilayer film of the invention is preferably not thermoformable, and also in particular not deep-draw thermoformable.

It is preferable that layer A and/or layer B of the film of the invention is transparent. For the purposes of the invention, a feature of a “transparent layer” is that a packaged product is visible to the naked eye through said layer.

Transparency is preferably quantified with the aid of densitometers. These methods are familiar to the person skilled in the art. Preferably haze is an optical value that can be measured to give a measure of transparency. Haze is preferably measured to the ASTM test standard D1003-61 m, procedure A, after calibration of the test equipment using standard haze specimens of haze from 0.3% to 34%. An example of a suitable test instrument is a Hazemeter from Byk-Gardner with Ulbricht sphere, permitting integrated measurement of diffuse light transmission properties in a range of solid angles from 8° to 160°.

The haze, in the unprinted state, of the individual layers of the multilayer film of the invention, determined by the method described above, is preferably less than 14%, more preferably less than 12%, still more preferably less than 10%. most preferably less than 8%, and in particular less than 6%.

The haze of the multilayer film per se at least in any unprinted regions is preferably less than 30%, more preferably less than 25%, still more preferably less than 20%, most preferably less than 15%, and in particular less than 10%.

In one preferred embodiment, starting from region D, the total haze of all of any layers that may be present located on the side of the layer A, inclusive of the layer A, is less than 30%, more preferably less than 28%, still more preferably less than 26%, most preferably less than 24%, and in particular less than 22%. In another preferred embodiment, starting from region D, the total haze of all of any layers that may be present located on the side of the layer B, inclusive of the layer B, is less than 30%, more preferably less than 28%, still more preferably less than 26%, most preferably less than 24%, and in particular less than 22%.

The multilayer film of the invention encompasses at least one at least monoaxially, preferably biaxially, oriented layer. This can involve layer A, or layer B, or any layer present other than layer A and layer B.

The orientation of polymers through stretching of a film is familiar to the person skilled in the art. If thermoplastic polymers are oriented at temperatures at which the molecules retain the ability to slide across one another, but at which the relaxation times are very much greater than the time for which they are kept at an elevated temperature for the orientation process, the orientation achieved during the course of the orientation process is retained, i.e. the orientation of the polymer strands in the direction of orientation. Significant changes in properties result from the orientation process, both in the case of amorphous and in the case of semicrystalline thermoplastic polymers. Biaxial stretching is preferably carried out in machine direction and transversely thereto, and this stretching can be carried out simultaneously or sequentially. The area stretching ratio is preferably in the range from 5 to 60, more preferably from 7 to 55, still more preferably from 9 to 50, and in particular 9±2, 20±5 or 50±10.

In one embodiment of the multilayer film of the invention, layer A and/or layer B form(s) a surface of the multilayer film of the invention.

Independently of the other layer(s), the total thickness
of layer A and of all of the layers that may be present arranged on that side of layer A that faces away from layer B, and/or
of layer B and of all of the layers that may be present arranged on that side of layer B that faces away from layer A
   is preferably in the range from 5.0 to 100 μm, more preferably from 7.5 to 75 μm, still more preferably from 10 μm to 50 μm, most preferably from 10 μm to 40 μm, and in particular from 15 μm to 30 μm.

Layer A of the multilayer film of the invention is based on a polymer or on a polymer mixture with melting point Tₘ^{A}. Preferably 70° C.≦Tₘ^{A}≦260° C., more preferably 80° C.≦Tₘ^{A}≦240° C., still more preferably 90° C.≦Tₘ^{A}≦220° C., most preferably 100° C.≦Tₘ^{A}≦200° C. and in particular 110° C.≦Tₘ^{A}≦180° C.

The melt flow index of the polymers or, respectively, of the mixture of the polymers on which layer A is based (MFI^{A}, ISO 1133/ASTM D1238; 2.16 kg/10 min) is preferably in the range 0.3 to 9.5 g/10 min; more preferably 3.5±2.0 g/10 min, 5.5±2.0 g/10 min or 7.5±2.0 g/10 min; still more preferably 3.0±1.5 g/10 min, 4.0±1.5 g/10 min, 5.0±1.5 g/10 min, 6.0±1.5 g/10 min, 7.0±1.5 g/10 min or 8.0±1.5 g/10 min; most preferably 2.5±1.0 g/10 min, 3.5±1.0 g/10 min, 4.5±1.0 g/10 min, 5.5±1.0 g/10 min, 6.5±1.0 g/10 min, 7.5±1.0 g/10 min or 8.5±1.0 g/10 min; in particular 1.0±0.5 g/10 min, 1.5±0.5 g/10 min, 2.0±0.5 g/10 min, 2.5±0.5 g/10 min, 3.0±0.5 g/10 min, 3.5±0.5 g/10 min, 4.0±0.5 g/10 min, 4.5±0.5 g/10 min, 5.0±0.5 g/10 min, 5.5±0.5 g/10 min, 6.0±0.5 g/10 min, 6.5±0.5 g/10 min, 7.0±0.5 g/10 min, 7.5±0.5 g/10 min, 8.0±0.5 g/10 min, 8.5±0.5 g/10 min or 9.0±0.5 g/10 min. In the case of polyethylene and of ethylene copolymers, the melt flow index is usually measured at 190° C., and in the case of polypropylenes and of propylene copolymers it is usually measured at 230° C.

The viscosity number of the polymers or, respectively, of the mixture of the polymers on which layer A is based (determined to ISO 307, solution, 0.005 g/ml of H₂SO₄), is preferably in the range 190±75 ml/g, more preferably 190±50 ml/g, still more preferably 190±30 ml/g, and in particular 190±10 ml/g.

The intrinsic viscosity of the polymers or, respectively, of the mixture of the polymers on which layer A is based (νᵢₙₜ^{A} determined to DIN 51562-3) is preferably in the range 0.8±0.3 dl/g, more preferably 0.8±0.2 dl/g, and in particular 0.8±0.1 dl/g.

In one preferred embodiment, the density ρ^{A} of the polymers or, respectively, of the mixture of the polymers on which layer A is based (ISO 1183/ASTM D792) is in the range≧1.00 g cm⁻³, more preferably ≧1.10 g cm⁻³, still more preferably ≧1.15 g cm⁻³, most preferably ≧1.20 g cm⁻³, and in particular ≧1.25 g cm⁻³. In another preferred embodiment, the density ρ^{A} of the polymers or, respectively, of the mixture of the polymers on which layer A is based (ISO 1183/ASTM D792) is in the range≦1.00 g cm⁻³, more preferably ≦0.98 g cm⁻³, still more preferably ≦0.96 g cm⁻³, most preferably ≦0.94 g cm⁻³, and in particular ≦0.92 g cm⁻³.

It is preferable that layer A is based on at least one polymer selected from the group consisting of (co)polyolefins, (co)polyesters, (co)polycarbonates, and (co)polyamides.

For the purposes of the description, the term “(co)polyoefin” encompasses both polyolefins and copolyolefins. Correspondingly, the term “(co)polyesters” encompasses both polyesters and copolyesters, the term “(co)polycarbonates” encompasses both polycarbonates and copolycarbonates, and the term “(co)poly-amides” encompasses both polyamides and copolyamides.

(Co)polyolefins preferred in the invention are those selected from the group consisting of PE (in particular LDPE, LLDPE, HDPE or mPE), PP, PI, PB, EAA, EMAA, EVA, EPC, PMMA, I, PS, SEP, SEPS, SEBS, SEEPS, and thermoplastic elastomers, and their copolymers.

“PE” means polyethylene, and “PP” means polypropylene. “LDPE” means low-density polyethylene, the density of which is in the range from 0.86 to 0.93 g/cm³, and which features a high degree of branching of the molecules. Linear low-density polyethylene (LLDPE) is a subspecies of LDPE and contains not only ethylene but, as comonomer, one or more α-olefins having more than 3 carbon atoms, e.g. 1 butene, 1-hexene, 4-methyl-1-pentene, and 1-octene. Copolymerization of the monomers mentioned gives the molecular structure typical of LLDPE, characterized by a linear main chain with side chains situated thereon. Density varies from 0.86 to 0.94 g/cm³. The melt flow index MFR of polyethylene-based polymers is preferably from 0.3 to 15 g/10 min (using 190° C./2.16 kg load, measured to DIN EN ISO 1133). The melt flow index MFR of polypropylene-based polymers is preferably from 0.3 to 30 g/10 min (using 230° C./2.16 kg load, measured to DIN EN ISO 1133). “HDPE” means high-density polyethylene, which has only a small amount of branching of the molecular chain, and density here can be in the range from 0.94 to 0.97 g/cm³. “mPE” means an ethylene copolymer polymerized by means of metallocene catalysts. The comonomer used preferably comprises an α-olefin having 4 or more carbon atoms. Density is preferably from 0.88 to 0.93 g/cm³. Polydispersity M_{w}/Mₙ is preferably smaller than 3.5, with preference smaller than 3.0.

“PI” means polyisobutylene, and “PB” means polybutylene.

“EAA” means copolymers composed of ethylene and acrylic acid, and “EMAA” means copolymers composed of ethylene and methacrylic acid. Ethylene content is in each case preferably from 60 to 99 mol %.

“EVA” means a copolymer composed of ethylene and vinyl acetate. Ethylene content is preferably from 60 to 99 mol %.

“EPC” means ethylene-propylene copolymers having from 1 to 10 mol % of ethylene, where the ethylene has random distribution in the molecule.

“PMMA” means polymethyl methacrylate and its copolymers.

“I” means olefin-based copolymers whose molecules have crosslinking by way of ionic bonds (ionomers). Ionic bonding takes place reversibly, the result being separation of the ionic bond at conventional processing temperatures (about 180-290° C.) and regeneration of the ionic bond during the cooling phase. The polymers usually used are copolymers composed of ethylene with acrylic acids, crosslinked by way of sodium ions or by way of zinc ions, e.g. Surlyn®.

“PS” means polystyrenes and styrene copolymers. An example of a styrene copolymer is styrene-butadiene copolymer, e.g. Styroflex®.

“SEP” means hydrogenated poly(styrene-b-isoprene) block copolymers, “SEPS” means hydrogenated poly(styrene-b-isoprene-b-styrene) block copolymers, “SEBS” means hydrogenated poly(styrene-b-butadiene-b-styrene) block copolymers, and “SEEPS” means hydrogenated poly(styrene-b-isoprene/butadiene-b-styrene) block copolymers. They are obtainable by way of example as SEPTON®.

Examples of “thermoplastic elastomers” are styrene-vinyl-polyisoprene (block) copolymers, such as HYBRAR®. They encompass blocks composed of polystyrene, of vinylpolyisoprene, of polyisoprene, of hydrogenated vinylpolyisoprene, and of hydrogenated polyisoprene.

Preferred (co)polyesters in the invention are those selected from the group consisting of PET (in particular c-PET or a-PET), coPET, PBT, and coPBT. “PET” is polyethylene terephthalate, which can be produced from ethylene glycol and terephthalic acid. A distinction can also be made between amorphous PET (a-PET) and crystalline PET (c-PET). “coPET” means copolyesters which contain not only ethylene glycol and terephthalic acid but also further monomers, e.g. branched or aromatic diol glycols. “PBT” means polybutylene terephthalate, and “coPBT” means a copolyester of polybutylene terephthalate. PBT can be produced from 1,4-butanediol and terephthalic acid. The polyester or copolyester preferably has an intrinsic viscosity of from 0.1 to 2.0 dl/g, more preferably from 0.2 to 1.7 dl/g, still more preferably from 0.3 to 1.5 dl/g, most preferably from 0.4 to 1.2 dl/g, and in particular from 0.6 to 1.0 dl/g. Methods for determining intrinsic viscosity are known to the person skilled in the art. A detailed description of PET, PBT, polycarbonates (PC), and copolycarbonates (coPC) is found in Kunststoffhandbuch [Plastics handbook] volume 3/1-technische Thermoplaste: Polycarbonate, Polyacetale, Polyester, Celluloseester [Engineering thermoplastics: polycarbonates, polyacetals, polyesters and cellulose esters]; Carl Hanser Verlag, 1992, the entire contents of which are incorporated herein by way of reference.

(Co)polyamides preferred in the invention are aliphatic or (semi)aromatic. The polyamide is preferably aliphatic. The polyamide or copolyamide preferably has a melting point in the range from 160 to 240° C., more preferably from 170 to 222° C. The polyamide or copolyamide is preferably one selected from the group consisting of PA 4, PA 6, PA 7, PA 8, PA 9, PA 10, PA 11, PA 12, PA 4.2, PA 4.6, PA 6.6, PA 6.8, PA 6.9, PA 6.10, PA 6.12, PA 7.7, PA 8.8, PA 9.9, PA 10.9, PA 12.12, PA 6/6.6, PA 6.6/6, PA 6.2/6.2, and PA 6.6/6.9/6. PA 6 is particularly preferred. A detailed description of PA and coPA is found in Kunststoff-Handbuch [Plastics handbook] volume VI, Polyamide [Polyamides], Carl Hanser Verlag, Munich, 1966; and Melvin I. Kohan, Nylon Plastics Handbook, Carl Hanser Verlag, Munich, 1995, the entire contents of which are incorporated herein by way of reference.

The multilayer film of the invention has an external sealable layer. This can involve layer A, or layer B, or any layer present other than layer A and layer B. For the purposes of the description, when the expression “sealable layer S” is used, the sealable layer involves a layer other than layer A and layer B. By way of example, “S//A-D-B” represents a multilayer film in which the sealable layer S has been arranged on that side of the layer A that faces away from layer B. “//” here does not necessarily mean that the sealable layer S is in contact with the layer A. Instead, another possibility is that the arrangement has one or more intermediate layers between the sealable layer S and the layer A. For the purposes of the description, when the general expression “sealable layer” is used, the sealable layer can also be identical with layer A or layer B.

The sealable layer of the multilayer film of the invention is sealable and preferably heat-sealable. The sealable layer serves primarily for the welding of the film. In the case of tubular bag packaging, the sealable medium has to be capable of sealing with respect to itself, and in the case of packagings composed of lid and tray the sealable medium has to be capable of sealing with respect to another sealable film. The sealing process is described by way of example in Hernandez/Selke/Culter: Plastics Packaging, Carl Hanser Verlag, Munich, 2000. The sealable layer can be peelable.

It is preferable in the invention that the sealable layer is based on at least one (co)polyolefin. The polymers used for the production of the sealable layer are approved for the production of layers that come into contact with foods. In one preferred embodiment, the sealable layer is based on at least one polyolefin selected from the group consisting of mPE, HDPE, LDPE, LLDPE, EVA, EAA, I (preferably Surlyn®, e.g. using zinc ions), PP, preferably homoPP, and propylene copolymer, or on a mixture of these. The sealing temperatures are preferably in the range from 100° C. to 164° C. The melting point of the sealable layer is preferably from 90° C. to 164° C., particularly preferably from 95° C. to 130° C. The sealable layer can be equipped with the usual auxiliaries, such as antistatic agents, lubricants, slip agents, antiblocking agents, antifogging agents, and/or spacers.

In one preferred embodiment of the multilayer film of the invention, the arrangement has a printed region D between layer A and layer B. To this end, layer B can have been printed on the side facing toward layer A, and/or layer A can have been printed on the side facing toward layer B.

The printed region is preferably based on conventional printing inks. For the purposes of the description, “printing inks” are preferably colored liquids or pastes which can be used for reproducible transfer of a printed image, i.e. a print, from a print carrier or printing block to a substrate, i.e. to at least one layer of the multilayer film of the invention. Printing inks are usually composed of binders, colorants (pigments, dyes), solvents, and additives.

The binders here usually have two functions—they firstly wet and coat the colorant component and transfer the same to the substrate by way of the inking system and the printing block, and secondly they fix the pigments on the substrate and produce a robust print. Typical binders are: a) semisynthetic polymers (modified natural products), e.g. cellulose derivatives, such as nitrocellulose, ethylcellulose, cellulose acetate propionate, or cellulose acetate butyrate; and b) entirely synthetic polymers: petroleum-based products, polyvinyl butyral resins (PVB), polyvinyl chloride copolymers (based on PVC), polyacrylates, polyamides, and polyurethanes (PU).

Colorants encompass all colorant substances, e.g. pigments, dyes, and pigment preparations. Dyes are substances soluble in the application medium, while pigments are practically insoluble in the application medium.

The application medium is composed of binder and solvent, and also, if appropriate, of conventional additives. Typical solvents are organic, e.g. ethanol, ethyl acetate, acetone, propanol, methyl ethyl ketone, etc. Additives modify the property profile of the printing ink, for example adhesion, elasticity, and slip properties.

It is also possible to use solvent-free printing inks, which generally harden by virtue of radiation-induced crosslinking (e.g. UV radiation or electron beams).

In one preferred embodiment of the multilayer film of the invention, the arrangement has a metallized region D between layer A and layer B. To this end, layer B can have been metallized on the side facing toward the layer A, and/or layer A can have been metallized on the side facing toward the layer B, and metallization here can be full-surface metallization or, if appropriate, can cover only a portion of the main plane of the multilayer film.

Metallization processes are known to the person skilled in the art. The usual method here uses metal, such as aluminum, deposited from the vapor in vacuo onto a polymer layer. The metal deposits on the polymer, thus forming a thin film. By way of example, a prefabricated polymer film can be introduced into a vacuum chamber and a vacuum in the range from 10⁻⁴ to 10⁻⁵ bar can be generated with the aid of suitable pumps. The metal, such as aluminum, is then heated to a temperature in the range from 1400 to 1500° C., thus producing a cloud of metal vapors in the vacuated space through which the polymer film is passed. A very thin metal layer is thus deposited on the surface of the polymer film. It is preferable here that one entire surface of the polymer film is metallized. It is possible to vary the temperature, vacuum, geometry of the vacuum chamber, and speed of the polymer film passing through the metal vapor, and the thickness of the metal film can thus be adjusted. The thickness of the metal film can be measured either electrically or optically.

In one preferred embodiment of the multilayer film of the invention, the arrangement has, between layer A and layer B, a region D that has been coated with a (semi)metal oxide. For the purposes of the description, the term “(semi)metal oxide” encompasses both semimetal oxides (e.g. SiOₓ) and metal oxides (e.g. AlOₓ). To this end, layer B can have been coated with a (semi)metal oxide on the side facing toward the layer A, and/or layer A can have been coated with a (semi)metal oxide on the side facing toward the layer B.

The (semi)metal oxide is preferably AlOₓ or SiOₓ. The coating process can be carried out by way of example by chemical vapor deposition (CVD) or physical vapor deposition (PVD). These processes are known to the person skilled in the art. By way of example, it is possible to vaporize aluminum in vacuo and to deposit AlOₓ by adding a certain amount of oxygen. In the case of silicon, the material can be vaporized with the aid of an electron beam. For further details, reference can be made by way of example to the entire contents of U.S. Pat. No. 5,728,224.

The region D of the multilayer film of the invention can have been treated on one side with a primer. Primers are substances which are applied in the form of a comparatively thin film, the usual thickness being less than 0.05 μm, and which modify the surface properties of the substrate. They differ inter alia in their application thickness from lamination adhesives, the application thickness of which is usually more than 0.5 μm, because of their viscosity. In contrast to this, primers can be applied in the form of monomolecular film. A primer can be defined as a surface coating which promotes adhesion to a substrate. Primers can have reactive functional groups which can react with functional groups of the polymers. Any primer present is not considered to be an independent layer, and therefore here again layer A is immediately adjacent to layer B, i.e. there is no further layer located between layer A and layer B.

In one preferred embodiment, layer B has a thickness of at most 50%, more preferably at most 40%, still more preferably at most 30%, most preferably at most 20%, and in particular at most 10%, of the total thickness of the layer B and of all of the layers arranged on that side of layer B that faces away from layer A. If by way of example the multilayer film has the structure A-D-B//C, the thickness of the layer B is at most the abovementioned percentage proportions of the entirety of the layer B and of the layer C.

Layer B is preferably based on a polymer or, respectively, a polymer mixture with melt flow index MFI^{B} (ISO 1133/ASTM D1238; 2.16 kg/10 min) in the range from 0.3 to 6.0 g/10 min; more preferably 2.5±1.0 g/10 min, 3.5±1.0 g/10 min, or 4.5±1.0 g/10 min; particularly preferably 1.5±0.5 g/10 min, 2.0±0.5 g/10 min, 2.5±0.5 g/10 min, 3.0±0.5 g/10 min, 3.5±0.5 g/10 min, 4.0±0.5 g/10 min, 4.5±0.5 g/10 min, or 5.0±0.5 g/10 min. In the case of polyethylene and of ethylene copolymers, the melt flow index is usually measured at 190° C., and in the case of polypropylenes and of propylene copolymers the melt flow index is usually measured at 230° C.

In one preferred embodiment, MFI^{A}>MFI^{B}. In another preferred embodiment, MFI^{A}<MFI^{B}.

Layer B is preferably based on a polymer or, respectively, a polymer mixture with density ρ^{B} (ISO 1183/ASTM D792) in the range 0.95±0.10 g cm⁻³, more preferably 0.90±0.05 g cm⁻³, 0.95±0.05 g cm⁻³, or 1.00±0.05 g cm⁻³; more preferably 0.935±0.025 g cm⁻³; more preferably 0.930±0.020 g cm⁻³, or 0.940±0.020 g cm⁻³; still more preferably 0.925±0.015 g cm⁻³, 0.935±0.015 g cm⁻³, or 0.945±0.015 g cm⁻³; most preferably 0.920±0.010 g cm⁻³, 0.930±0.010 g cm⁻³, 0.940±0.010 g cm⁻³, or 0.950±0.010 g cm⁻³; and in particular 0.920±0.005 g cm⁻³, 0.925±0.005 g cm⁻³, 0.930±0.005 g cm⁻³, 0.935±0.005 g cm⁻³, 0.940±0.005 g cm⁻³, 0.945±0.005 g cm⁻³, or 0.950±0.005 g cm⁻³.

In one preferred embodiment, ρ^{A}>ρ^{B}. In another preferred embodiment, ρ^{A}<ρ^{B}.

In one preferred embodiment, layer B is based on at least one (co)polyolefin, preferably on a polyethylene, ethylene copolymer, polypropylene, propylene copolymer, polystyrene, styrene copolymer, polybutene, butene copolymer, polyisoprene, isoprene copolymer, or a mixture of these. Ethylene copolymers are preferred, particular preference being given to those selected from the group consisting of ethylene-alkyl acrylate copolymer, ethylene-vinyl acetate copolymer, ethylene-maleic anhydride copolymer, and ethylene-alkyl acrylate-maleic anhydride copolymer.

If layer B is based on an ethylene-alkyl acrylate copolymer, the alkyl acrylate is preferably methyl acrylate, ethyl acrylate, or butyl acrylate. The proportion of the alkyl acrylate is preferably in the range from 10 to 40 mol %, more preferably from 15 to 35 mol %, still more preferably from 20 to 30 mol %. An example of a suitable ethylene-methacrylate copolymer is Elvaloy® AC1224, which has a density of 0.944 g cm⁻³ and a melt flow index of 2 g/10 min, and which contains a proportion of 24 mol % of methyl acrylate.

If layer B is based on an ethylene-vinyl acetate copolymer, the proportion of vinyl acetate is preferably in the range from 10 to 40 mol %, more preferably from 15 to 35 mol %, still more preferably from 20 to 30 mol %. An example of a suitable ethylene-vinyl acetate copolymer is Elvax® 3190LG, which has a density of 0.950 g cm⁻³ and a melt flow index of 2 g/10 min, and contains a proportion of 25 mol % of vinyl acetate.

If layer B is based on an ethylene-maleic anhydride copolymer, this preferably involves a maleic-anhydride-modified, linear low-density polyethylene (LLDPE). The proportion of maleic anhydride is preferably in the range from 0.5 to 5.0 mol %, more preferably from 1.0 to 4.5 mol %, still more preferably from 1.5 to 40 mol %. An example of a suitable ethylene-maleic anhydride copolymer is Bynel® 4157N, which has a density of 0.920 g cm⁻³ and a melt flow index of 3 g/10 min.

If layer B is based on an ethylene-alkyl acrylate-maleic anhydride copolymer, the alkyl acrylate is preferably methyl acrylate, ethyl acrylate, or butyl acrylate. The proportion of the alkyl acrylate is preferably in the range from 1.0 to 20 mol %, more preferably from 2.0 to 15 mol %, still more preferably from 3.0 bis 10 mol %, and the proportion of the maleic anhydride is preferably in the range from 1.0 to 10 mol %. more preferably from 1.5 to 7.5 mol %, still more preferably from 2.0 to 5.0 mol %. An example of a suitable ethylene-alkyl acrylate-maleic anhydride copolymer is Lotader® 3210, which has a density of 0.930 g cm⁻³ and a melt flow index of 5 g/10 min, and contains a proportion of 6.0 mol % of butyl acrylate and a proportion of 3.0 mol % of maleic anhydride.

In one preferred embodiment of the multilayer film of the invention, on that side of layer B that faces away from layer A a layer C has been arranged which is based on a thermoplastic polymer. Accordingly, the multilayer film of the invention preferably has the layer sequence A-D-B//C. It is preferable that layer C is an at least monoaxially, with preference biaxially, stretched and/or transparent layer. It is preferable that layer C forms an external surface of the multilayer film.

Layer C preferably has a thickness in the range from 5.0 to 150 μm, more preferably from 7.5 to 125 μm, still more preferably from 10 to 100 μm, most preferably from 12.5 to 75 μm, and in particular from 15 to 50 μm.

Layer C is preferably based on at least one (co)polyolefin, preferably on polyethylene, ethylene copolymer, polypropylene, propylene copolymer, polystyrene, styrene copolymer, or a mixture of these. Layer C is preferably based on a polymer or, respectively, a polymer mixture with density ρ^{C} in the range from 0.90 to 1.20 g cm⁻³. In one preferred embodiment, ρ^{C}>ρ^{B}. In another preferred embodiment, ρ^{C}<ρ^{B}.

Layer C is particularly preferably based on polyethylene, with preference low-density polyethylene (LDPE), i.e. polyethylene of density in the range from 0.915 to 0.935 g cm⁻³. The density is more preferably in the range from 0.920 to 0.935 g cm⁻³, still more preferably from 0.925 to 0.935 g cm⁻³, and in particular from 0.930 to 0.935 g cm⁻³. The melt flow index MFI^{C} is preferably in the range from 1.5 to 4.5 g/10 min, more preferably from 2.0 to 4.0 g/10 min, and in particular from 2.5 to 3.5 g/10 min. An example of a suitable LDPE is ExxonMobil® LD 151, which has a density of 0.9335 g cm⁻¹ and a melt flow index of 3 g/10 min.

Layer C is preferably based on a (co)polyolefin or on a mixture of a plurality of (co)polyolefins with melting point Tₘ^{C} and with VICAT softening point Tᵥ^{C}, where Tₘ^{C}>Tₘ^{B} and/or Tᵥ^{C}>Tᵥ^{B}, preferably Tₘ^{C}≧Tₘ^{B}≧Tᵥ^{C}≧Tᵥ^{B}, or Tₘ^{C}≧Tᵥ^{C}>Tₘ^{B}≧Tᵥ^{B}.

In one preferred embodiment, MFI^{C}>MFI^{B}. In another preferred embodiment, MFI^{C}<MFI^{B}.

In one preferred embodiment of the multilayer film of the invention, both ρ^{B} and ρ^{C} are in the range 0.935±0.015 g cm⁻³, and MFI^{C}>MFI^{B} or MFI^{B}>MFI^{C}, preferably with both MFI^{B} and MFI^{C} in the range 2.5±1.5 g/10 min, more preferably 2.5±1.0 g/10 min, still more preferably 2.5±0.5 g/10 min.

There can be one or more intermediate layers arranged between layer B and any layer C present in the multilayer film of the invention. However, it is preferable that layer C is immediately adjacent to layer B.

The multilayer film of the invention can have, alongside layer A, layer B, the sealable layer, and any layer C present, one or more further layers which can form intermediate or exterior layers of the multilayer film. The further layers, identical or different, that may be present are preferably based on thermoplastic polymers selected from (co)polyolefins, (co)polyesters, and (co)polyamides. The polymers can, if appropriate, have been foamed.

In one preferred embodiment, the multilayer film of the invention has a barrier layer BA, which is preferably impermeable to gas and/or to aroma. The barrier layer BA can also provide protection from moisture, and/or can inhibit the migration of low-molecular-weight constituents of the multilayer film into the packaged product. It is preferable that the gas-impermeability value of the multilayer film of the invention, determined to DIN 53380, is less than 50, more preferably less than 40, still more preferably less than 25, and in particular less than 10 [cm³/m²d bar O₂] at 23° C. and 0% rel. humidity.

Any barrier layer BA present is preferably based on at least one polymer selected from the group consisting of ethylene-vinyl alcohol copolymer (EVOH); polyvinylidene chloride (PVDC), vinylidene chloride copolymer, preferably having a proportion of 80% or more of vinylidene chloride, preferably Saran®, if appropriate also in the form of blend with other polymers, such as EVA; polyester and polyamide; preferably on ethylene-vinyl alcohol copolymer. Any barrier layer BA present preferably has a thickness of from 0.5 to 15 μm, more preferably from 1.0 to 10 μm, still more preferably from 1.5 to 9 μm, most preferably from 2.0 to 8 μm, and in particular from 2.5 to 7.5 μm.

The barrier layer BA has preferably been embedded into two adhesion-promoter layers HV₁ and HV₂ and/or two polyamide layers PA₁ and PA₂. The multilayer film of the invention therefore preferably encompasses, alongside layer A, layer B, if appropriate layer C, and if appropriate the sealable layer S, the following layers in the following sequence:
if appropriate, an adhesion-promoter layer HV₁;
if appropriate, a polyamide layer PA₁;
a barrier layer BA impermeable to gas and/or to aroma;
if appropriate, a polyamide layer PA₂; and
if appropriate, an adhesion-promoter layer HV₂.

Adhesion promoters (HV) are coextrudable, adhesion-promoting polymers. They preferably involve modified polyolefins, e.g. LDPE, LLDPE, mPE, EVA, EAA, EMAA, (co)PP, or EPC, where these have been grafted with at least one monomer from the group of α,β-monounsaturated dicarboxylic acids, e.g. maleic acid, fumeric acid and itaconic acid, or with their anhydrides, esters, amides, or imides. Other materials that can also be used are copolymers of ethylene with α,β-monounsaturated monocarboxylic acids, such as acrylic acid or methacrylic acid, and/or their metal salts with zinc or sodium, and/or their C₁-C₄-alkyl esters, and the materials here can also have been grafted with at least one monomer from the group of α,β-monounsaturated dicarboxylic acids, e.g. maleic acid, fumaric acid, and itaconic acid, or with their anhydrides, esters, amides, or imides. It is moreover also possible to use polyolefins, e.g. PE, PP, ethylene-propylene copolymers, or ethylene-α-olefin copolymers, where these have been grafted with copolymers of ethylene with α,β-monounsaturated monocarboxylic acids, such as acrylic acid or methacrylic acid, and/or their metal salts with zinc or sodium, and/or their C₁-C₄-alkyl esters. Particularly suitable adhesion promoters are polyolefins, in particular ethylene-α-olefin copolymers with a graft of α,β-monounsaturated dicarboxylic anhydride, in particular maleic anhydride. The adhesion promoters can also comprise an ethylene-vinyl acetate copolymer (EVA), preferably with vinyl acetate content of at least 10% by weight.

Any adhesion promoter(s) HV₁ and HV₂ present, identical or different, preferably has/have a thickness of from 0.1 to 25 μm, more preferably from 0.2 to 15 μm, still more preferably from 0.5 to 10 μm, most preferably from 1.0 to 7.5 μm, and in particular from 2.0 to 5.0 μm.

Any polyamide layer(s) PA₁ and PA₂ present is/are preferably based on the polyamides listed above in connection with the polyamides for layer A, and the thickness(es) of this/these, identical or different, is/are preferably from 0.1 to 25 μm, more preferably from 0.2 to 15 μm, still more preferably from 0.5 to 10 μm, most preferably from 1.0 to 7.5 μm, and in particular from 2.0 to 5.0 μm.

The multilayer film of the invention preferably has the layer sequence S//A-D-B//C, where in particular the arrangement can have one, two, three, or four additional intermediate layers between the sealable layer S and layer A. For the purposes of the description, this is expressed by the symbol “//”.

Preferred layer sequences of the multilayer film of the invention are shown below, and in each case here it is possible, if appropriate, that further, unspecified (intermediate) layers can be present:
A-D-B;
A-D-B//C, S//A-D-B;
A-D-B//C//S, S//A-D-B//C;
A-D-B//HV₁//BA//HV₂//S, S//HV₁//BA//HV₂//A-D-B, A-D-B//PA₁//BA//PA₂//S, S//PA₁//BA//PA₂//A-D-B;
A-D-B//C//HV₁//BA//HV₂//S, S//HV₁//BA//HV₂//A-D-B//C, A-D-B//C//PA₁//BA//PA₂//S, S//PA₁//BA//PA₂//A-D-B//C;
A-D-B//HV₁//PA₁//BA//PA₂//HV₂//S, S//HV₁//PA₁//BA//PA₂//HV₂//A-D-B;
A-D-B//C//HV₁//PA₁//BA//PA₂//HV₂//S or S//HV₁//PA₁//BA//PA₂//HV₂//A-D-B//C.

The table below collates particularly preferred embodiments of the multilayer film of the invention; the thickness of the individual layers here is preferably within the stated ranges (all values being in μm), and further unspecified (intermediate) layers can be present if appropriate:

| | A | B | C |
|---|---|---|---|
| Polymer | (Co)polyolefin, | Ethylene copolymer, propylene | (Co)polyolefin |
| | (co)polyester, or | copolymer, or styrene copolymer | |
| | (co)polyamide | | |
| Thickness | 1-50 μm | 1-40 μm | 10-50 μm |
| Polymer | (Co)polyolefin, | Ethylene copolymer, propylene | (Co)polyolefin |
| | (co)polyester, or | copolymer, or styrene copolymer | |
| | (co)polyamide | | |
| Thickness | 1-50 μm | 10-40 μm | 10-50 μm |
| Polymer | (Co)polyolefin, | Ethylene copolymer, propylene | (Co)polyolefin |
| | (co)polyester, or | copolymer, or styrene copolymer | |
| | (co)polyamide | | |
| Thickness | 1-50 μm | 1-40 μm | 10-50 μm |
| Polymer | (Co)polyolefin, | Ethylene copolymer, propylene | (Co)polyolefin |
| | (co)polyester, or | copolymer, or styrene copolymer | |
| | (co)polyamide | | |
| Thickness | 1-50 μm | 1-40 μm | 10-50 μm |
| Polymer | BOPP, BOPET, or | Ethylene-alkyl acrylate | LDPE |
| | BOPA | copolymer | |
| Thickness | 1-50 μm | 1-30 μm | 10-40 μm |
| Polymer | BOPP, BOPET, or | Ethylene methacrylate | LDPE |
| | BOPA | copolymer | |
| Thickness | 1-50 μm | 1-30 μm | 10-40 μm |
| Polymer | BOPP, BOPET, or | Ethylene vinyl acetate copolymer | LDPE |
| | BOPA | | |
| Thickness | 1-50 μm | 1-30 μm | 10-40 μm |
| Polymer | BOPP, BOPET, or | Ethylene maleic anhydride | LDPE |
| | BOPA | copolymer | |
| Thickness | 1-50 μm | 1-30 μm | 10-40 μm |
| Polymer | BOPP, BOPET, or | Ethylene-alkyl acrylate-maleic | LDPE |
| | BOPA | anhydride copolymer | |
| Thickness | 1-50 μm | 1-30 μm | 10-40 μm |
| Polymer | BOPP, BOPET, or | Ethylene-butyl acrylate-maleic | LDPE |
| | BOPA | anhydride copolymer | |
| Thickness | 1-50 μm | 1-30 μm | 10-40 μm |

The individual layers of the multilayer film of the invention can comprise conventional amounts of conventional auxiliaries, examples being pigments, lubricants, spacers, antifogging agents, etc.

The invention also provides a process for the production of the multilayer film described above, composed of
(i) a film 1 encompassing layer A, which forms at least one of the two surfaces of the film 1, and which has, on at least one portion of said surface, a region D that has been printed and/or that has been metallized and/or that has been coated with a (semi)metal oxide;
   and
(ii) a film 2 encompassing layer B, which forms at least one of the two surfaces of the film 2, where said surface has, if appropriate, been treated with corona discharge;
   where film 1 and/or film 2 encompasses at least one at least monoaxially oriented layer, and the process encompasses the following steps:
   a) combining film 1 and film 2 so that the region D comes into direct contact with layer B of the film 2; and
   b) bonding of film 1 and film 2 via thermocompression at a pressure p and at a temperature T, where T is below Tₘ^{A} and above Tᵥ^{B}.

It is preferable that T is below Tᵥ^{A} and/or below Tₘ^{B}.

In one preferred embodiment of the process of the invention, T is in the range from 50° C. to 130° C., more preferably from 60° C. to 130° C., still more preferably from 70° C. to 130° C., most preferably from 80° C. to 130° C., and in particular from 90° C. to 130° C. In another preferred embodiment of the process of the invention, T is in the range from 50° C. to 130° C., more preferably from 50° C. to 120° C., still more preferably from 50° C. to 110° C., most preferably from 50° C. to 100° C., and in particular from 50° C. to 90° C.

p is preferably at least 5.0 N/mm, more preferably at least 10 N/mm, still more preferably at least 15 N/mm, most preferably at least 20 N/mm, and in particular at least 25 N/mm. The pressure p is preferably in the range from 17.5 to 35 N/mm.

In one preferred embodiment of the process of the invention, each section of the multilayer film is heated to the temperature T for a period of at most 10 seconds, more preferably at most 5 seconds, still more preferably at most 1 second, most preferably at most 0.5 second, and in particular at most 0.1 second.

The invention further provides a multilayer film obtainable by the process described above.

The invention further provides a packaging which encompasses the multilayer film described above. The packaging preferably involves a sealed tubular bag or a sealed packaging composed of tray and lid, where the multilayer film forms the lid.

The adhesion between layer A and layer B of the multilayer film of the invention is preferably determined to DIN 53 357, method B.

The curl of the multilayer film of the invention is preferably determined by the crosscut method. In this method, the curl is defined as the distance between the curled edges of a crosscut, separately for the longitudinal and transverse direction. This distance is stated in mm.

The sample is preferably taken from an inner lap of the roll of the multilayer film. In the case of rolls freshly manufactured, the sample should be taken from a fixed lap, i.e. at least the 2nd layer of film. The sample should be taken from the roll immediately prior to the test, and the curl should be measured immediately.

A preliminary experiment is used to determine the side toward which the film curls, in order that the sample is placed with the curling tips upward. If the direction of curl is different in the two test directions, it may be necessary to test 2 samples respectively with exterior and interior side upward. It is not possible to evaluate samples where tips curl toward the underlay.

The test is preferably carried out at 23° C. and at average humidity.

For the test, a template as in FIGS. 1 and 2 is superposed in such a way that the cuts are made diagonally with respect to the direction of running of the film. The cut length is in each case 113±1 mm. The template is removed immediately after cutting. The template in FIGS. 1 and 2 encompasses a metal sheet 1 of thickness 3 mm, two spherical plastics heads 2 with a diameter of 32 mm, two countersunk bolts 3, two nuts 4, and two underlay sheets 5. The distance between the two mutually parallel bolt axes is 132 mm.

30 seconds after cutting, the distance between the curl extremities is measured separately for the longitudinal and the transverse direction, the measurement being made from tip to tip in the case of small amounts of curl, or from inner extremity to inner extremity in the case of larger amounts of curl (cf. FIG. 3).

The examples below serve to illustrate the invention, but are non-restricting.

### INVENTIVE EXAMPLE 1

Multilayer films of general structure A-D-B//C were produced by joining composite A-D and composite B-C. For this, one of the surfaces of layer A was printed. The printed image was joined without alteration, i.e. without primer-treatment, to the composite B//C at the stated temperatures, under pressure.

The table below collates the specific structure of the individual layers; the adhesion (VH in [N/15 mm]) measured to DIN 53 357, method B between the layers A and B is stated in the final column as a function of the temperature T:

| | | μm | | μm | A | μm | B | μm | C | μm | T | VH |
|---|---|---|---|---|---|---|---|---|---|---|---|---|
| 1 | | | | | BOPA-6 | 15 | Elvaloy ® 1224 AC | 20 | ExxonMobil ® | 30 | 90° C. | 0.8 |
| | | | | | Tₘ^{A} = 220° C. | | Tᵥ^{B} = 48° C. | | LD151 BW | | 130° C. | 1.3 |
| | | | | | | | Tₘ^{B} = 91° C. | | Tᵥ^{C} = 107° C. | | 150° C. | 3.7 |
| | | | | | | | | | Tₘ^{C} = 116° C. | | 180° C. | 5.1 |
| 2 | | | | | BOPET | 12 | Elvaloy ® 1224 AC | 20 | ExxonMobil ® | 30 | 90° C. | 5.1 |
| | | | | | Tₘ^{A} = 260° C. | | Tᵥ^{B} = 48° C. | | LD151 BW | | 130° C. | 6.9 |
| | | | | | | | Tₘ^{B} = 91° C. | | Tᵥ^{C} = 107° C. | | 150° C. | 3.8 |
| | | | | | | | | | Tₘ^{C} = 116° C. | | 180° C. | 5.7 |
| 3 | PP | 1 | BOPP | 18 | PP | 1 | Elvaloy ® 1224 AC | 20 | ExxonMobil ® | 30 | 90° C. | 8 |
| | | | Tₘ = | | Tᵥ^{A} = 117° C. | | Tᵥ^{B} = 48° C. | | LD151 BW | | 130° C. | 6.9 |
| | | | 164° C. | | Tₘ^{A} = 132° C. | | Tₘ^{B} = 91° C. | | Tᵥ^{C} = 107° C. | | 150° C. | 9.1 |
| | | | | | | | | | Tₘ^{C} = 116° C. | | 180° C. | 8.3 |
| 4 | PP | 1 | BOPP | 18 | PP | 1 | Lotader ® 3210 | 20 | ExxonMobil ® | 30 | 90° C. | 5.2 |
| | | | Tₘ = | | Tᵥ^{A} = 117° C. | | Tᵥ^{B} = 80° C. | | LD151 BW | | 130° C. | 7.4 |
| | | | 164° C. | | Tₘ^{A} = 132° C. | | Tₘ^{B} = 107° C. | | Tᵥ^{C} = 107° C. | | 150° C. | 6.1 |
| | | | | | | | | | Tₘ^{C} = 116° C. | | 180° C. | 8.1 |
| 5 | PP | 1 | BOPP | 18 | PP | 1 | Bynel ® 4157 N | 20 | ExxonMobil ® | 30 | 90° C. | 0 |
| | | | Tₘ = | | Tᵥ^{A} = 117° C. | | Tᵥ^{B} = 93° C. | | LD151 BW | | 130° C. | 6.4 |
| | | | 164° C. | | Tₘ^{A} = 132° C. | | Tₘ^{B} = 127° C. | | Tᵥ^{C} = 107° C. | | 150° C. | 6.5 |
| | | | | | | | | | Tₘ^{C} = 116° C. | | 180° C. | 11 |

As shown by the above adhesion values, as a function of the constitution of the polymers of layer A and layer B, it is possible to find a suitable temperature T at which the adhesion achieved is at least 1.0 N/15 mm. Routine experiments can be used to find the ideal temperature T.

### INVENTIVE EXAMPLE 2

By analogy with inventive example 1, multilayer films of the general structure A-D-B//C were produced by joining composite A-D and composite B-C. However, a Polytest laboratory lamination system from Polytype was used for this purpose, the speed here being 5 m/min and the temperature of the lamination roll being 80° C.

The table below collates the specific structure of the individual layers; the adhesion (VH) measured to DIN 53 357, method B between the layers A and B is stated in the final column:

| | | μm | | μm | A | μm | B | μm | C | μm | T | VH |
|---|---|---|---|---|---|---|---|---|---|---|---|---|
| 1 | | | | | BOPET | 12 | Elvaloy ® 1224 AC | 20 | ExxonMobil ® | 30 | 80° C. | 8.5 |
| | | | | | Tₘ^{A} = 260° C. | | Tᵥ^{B} = 48° C. | | LD151 BW | | | |
| | | | | | | | Tₘ^{B} = 91° C. | | Tᵥ^{C} = 107° C. | | | |
| | | | | | | | | | Tₘ^{C} = 116° C. | | | |
| 2 | PP | 1 | BOPP | 18 | PP | 1 | Elvaloy ® 1224 AC | 20 | ExxonMobil ® | 30 | 80° C. | 9 |
| | | | Tₘ = | | Tᵥ^{A} = 117° C. | | Tᵥ^{B} = 48° C. | | LD151 BW | | | |
| | | | 164° C. | | Tₘ^{A} = 132° C. | | Tₘ^{B} = 91° C. | | Tᵥ^{C} = 107° C. | | | |
| | | | | | | | | | Tₘ^{C} = 116° C. | | | |

### COMPARATIVE EXAMPLE

A commercially available printed and metallized (met) multilayer film produced via extrusion lamination with the following layer sequence was tested:
BOPP¹-D-\textcircled{1}-PE¹//P-E copolymer//-\textcircled{2}-PE²-\textcircled{3}-met-BOPP².
   “P-E copolymer” means a layer based on a propylene-ethylene copolymer.

The table below collates the layer thicknesses:

| | |
|---|---|
| BOPP¹ | 19 μm |
| BOPP² | 19 μm |
| PE¹ (m.p. 104° C.) | 6.9 μm |
| PE² (m.p. 104° C.) | 8.9 μm |
| P-E copolymer (m.p. 150° C.) | 3.2 μm |

The adhesion values measured to DIN 53 357, method B between the identified layers are stated in the table below:

| | |
|---|---|
| \textcircled{1} | 0.37 N/15 mm |
| \textcircled{2} | 0.60 N/15 mm |
| \textcircled{3} | 0.73 N/15 mm |

1. A multilayer film comprising
layer A, which is formed of a thermoplastic polymer or a mixture of thermoplastic polymers having a melting point Tₘ^{A}, a VICAT softening point Tᵥ^{A}, and a thickness of at most 40 μm; and
layer B, which is immediately adjacent to layer A, and which is formed of a thermoplastic polymer or a mixture of thermoplastic polymers, having a melting point Tₘ^{B}, a VICAT softening point Tᵥ^{B}, and a thickness of at most 50 μm;
where
Tᵥ^{B}<Tᵥ^{A} and Tₘ^{B}<Tₘ^{A};
Tᵥ^{B}≦115° C.;
at least one at least monoaxially oriented layer;
an external sealable layer;
a region D between layer A and layer B—that has been printed and/or that has been metallized and/or that has been coated with a (semi-)metal oxide; and wherein
the adhesion between layer A and layer B is at least 1.0 N/15 mm.

2. The multilayer film as claimed in claim 1, having a longitudinal and/or transverse curl of 50 mm at most.

3. The multilayer film of claim 1, wherein the adhesion between layer A and layer B is at least 2.0 N/15 mm.

4. The multilayer film of claim 1, having no lamination adhesive and/or no lacquer.

5. The multilayer film as claimed in claim 1, wherein 70° C.≦Tₘ^{A}≦260° C.

6. The multilayer film as claimed in claim 1, having a total of at most five layers, and/or a total layer thickness of at most 200 μm.

7. The multilayer film as claimed in claim 1, wherein layer A and/or layer B, independently of the other,
is transparent, and/or
has been at least monoaxially stretched and/or
forms a surface of the multilayer film.

8. The multilayer film as claimed in claim 1, wherein, independently of any other layer(s) that may be present, the total thickness
of layer A and of all of the layers that may be present arranged on that side of layer A that faces away from layer B, and/or
of layer B and of all of the layers that may be present arranged on that side of layer B that faces away from layer A
is in the range from 5.0 to 100 μm.

9. The multilayer film as claimed in claim 1, wherein layer A is formed of at least one polymer selected from the group consisting of (co)polyolefins, (co)polyesters, and (co)polyamides.

10. The multilayer film as claimed in claim 9, wherein
the (co)polyolefin is polyethylene (PE), polypropylene (PP), a copolymer of polyethylene or a copolymer of polypropylene;
the (co)polyester is selected from the group consisting of polyethylene terephthalate (PET), polybutylene terephthalate (PBT) and their copolymers; or
the (co)polyamide is selected from the group consisting of PA 4, PA 6, PA 7, PA 8, PA 9, PA 10, PA 11, PA 12, PA 4.2, PA 4.6, PA 6.6, PA 6.8, PA 6.9, PA 6.10, PA 6.12, PA 7.7, PA 8.8, PA 9.9, PA 10.9, PA 12.12, PA 6/6.6, PA 6.6/6, PA 6.2/6.2, PA 6.6/6.9/6, and their copolymers.

11. The multilayer film as claimed in claim 1, wherein layer B
is metallized on the side facing toward the layer A, and/or
has a thickness which is at most 50% of the total thickness of the layer B and of all of the layers arranged on that side of layer B that faces away from layer A, and/or
is formed of at least one (co)polyolefin.

12. The multilayer film as claimed in claim 11, wherein layer B is formed of polyethylene or of an ethylene copolymer.

13. The multilayer film as claimed in claim 12, wherein the ethylene copolymer is selected from the group consisting of ethylene-alkyl acrylate copolymer, ethylene-vinyl acetate copolymer, ethylene-maleic anhydride copolymer, and ethylene-alkyl acrylate-maleic anhydride copolymer.

14. The multilayer film as claimed in claim 1, wherein on that side of layer B that faces away from layer A a layer C formed of a thermoplastic polymer is arranged and
has been monoaxially or biaxially stretched; and/or
is transparent; and/or
forms an external surface of the multilayer film, and/or
has a thickness in the range from 5.0 to 40 μm, and/or
is comprised of at least one (co)polyolefin.

15. The multilayer film as claimed in claim 14, wherein layer C is based on polyethylene or an ethylene copolymer.

16. The multilayer film as claimed in claim 14, wherein layer C is based on a (co)polyolefin or on a mixture of a plurality of (co)polyolefins with melting point Tₘ^{C} and with VICAT softening point Tᵥ^{C}, where Tₘ^{C}>Tₘ^{B} and/or Tᵥ^{C}>Tᵥ^{B}.

17. The multilayer film as claimed in claim 14, wherein layer B is formed of a thermoplastic polymer or a mixture of a plurality of thermoplastic polymers, with density ρ^{B} and with melt flow index MFI^{B}, and layer C is formed of a (co)polyolefin or a mixture of (co)polyolefins, with density ρ^{C} and with melt flow index MFI^{C}, where both ρ^{B} and ρ^{C} are in the range 0.935±0.015 g cm⁻³, and both MFI^{B} and MFI^{C} are in the range 2.5±1.0 g/10 min (2.16 kg).

18. The multilayer film as claimed in claim 1, optionally further comprising, alongside layer A and layer B, one or more of the following layers in the following sequence:
an adhesion-promoter layer HV₁;
a polyamide layer PA₁;
a barrier layer BA impermeable to gas and/or to aroma;
a polyamide layer PA₂; and
an adhesion-promoter layer HV₂.

19. A process for the production of the multilayer film claim 1, composed of
(i) a film 1 encompassing layer A, which forms at least one of the two surfaces of the film 1, and which has, on at least one portion of said surface, a region D that has been printed and/or that has been metallized and/or that has been coated with a (semi)metal oxide;
and
(ii) a film 2 encompassing layer B, which forms at least one of the two surfaces of the film 2, where said surface has, optionally, been treated with corona discharge;
where film 1 and/or film 2 encompasses at least one at least monoaxially oriented layer, and the process encompasses the following steps:
a) combining film 1 and film 2 so that the region D comes into direct contact with layer B of the film 2; and
b) bonding of film 1 and film 2 via thermocompression at a pressure p and at a temperature T, where T is below Tₘ^{A} and above Tᵥ^{B}.

20. The process as claimed in claim 19, wherein T is below Tᵥ^{A} and/or below Tₘ^{B}.

21. The process as claimed in claim 19 wherein T is in the range from 50° C. to 130° C.

22. The process as claimed in claim 18, wherein each section of the multilayer film is heated at most for a period of 10 seconds to the temperature T.

23. A packaging comprising a multilayer film of claim 1.

24. The packaging as claimed in claim 23, in the form of
a sealed tubular bag, or
a sealed packaging composed of tray and lid, where the multilayer film forms the lid.

25. The multilayer film as claimed in claim 15, wherein layer C is based on a (co)polyolefin or on a mixture of a plurality of (co)polyolefins with melting point Tₘ^{C} and with VICAT softening point Tᵥ^{C}, where Tₘ^{C}>Tₘ^{B} and/or Tᵥ^{C}>Tᵥ^{B}.
